(19) United States
(12) Patent Application Publication
(10) Pub. No.: US 2025/0158251 A1
(43) Pub. Date: May 15, 2025

(54) LAMINATE TYPE BATTERY

(71) Applicant: TOYOTA JIDOSHA KABUSHIKI KAISHA, Toyota-shi (JP)

(72) Inventors: Yusuke IKEDA, Miyoshi-shi (JP); Kenichi KAKISHITA, Nagoya-shi (JP); Tomofumi HIRUKAWA, Miyoshi-shi (JP); Masashi UEDA, Toyota-shi (JP); Shinji KOJIMA, Nagoya-shi (JP); Masataka OGUSHI, Nisshin-shi (JP); Kosuke YONEKAWA, Nisshin-shi (JP)

(73) Assignee: TOYOTA JIDOSHA KABUSHIKI KAISHA, Toyota-shi (JP)

(21) Appl. No.: 18/812,261

(22) Filed: Aug. 22, 2024

(30) Foreign Application Priority Data
Nov. 15, 2023 (JP) 2023-194743

(51) Int. Cl. H01M 50/548; H01M 50/249

(52) U.S. Cl. CPC H01M 50/548; H01M 50/249

(57) ABSTRACT

A laminate type battery includes: an electrode body; a side-surface member disposed on a side surface of the electrode body; and a laminate film that covers the electrode body and a part of the side-surface member, in which: the side-surface member is disposed at a position deviated from a center of the side surface to one side in a longitudinal direction of the side surface; and in the side-surface member, the volume of the side-surface member positioned on a deviation side on the side surface is equal to the volume of the side-surface member positioned on a non-deviation side on the side surface, the deviation side being the one side to which the side-surface member is positioned so as to be deviated from the center in the longitudinal direction of the side surface, the non-deviation side being the other side in the longitudinal direction of the side surface.

### CROSS-REFERENCE TO RELATED APPLICATION

This application claims priority to Japanese Patent Application No. 2023-194743 filed on Nov. 15, 2023, incorporated herein by reference in its entirety.

### BACKGROUND

### 1. Technical Field

The present disclosure relates to a laminate type battery.

### 2. Description of Related Art

Conventionally, there has been used a laminate type battery including an electrode body, a side-surface member such as a terminal, and a laminate film that covers the electrode body and a part of the side-surface member.

For example, Japanese Unexamined Patent Application Publication No. 11-283611 discloses a battery in which a terminal on one side surface is disposed so as to be deviated from a center of the side surface to one side.

### SUMMARY

Conventionally, there has been used a laminate type battery including an electrode body, a side-surface member such as a terminal, and a laminate film that covers the electrode body and a part of the side-surface member. In some cases, in the laminate type battery, the side-surface member is disposed at a position that is deviated from a center of a side surface to one side in the longitudinal direction of the side surface.

However, in the electrode body on which the side-surface member is disposed so as to be deviated to one side on the side surface, the difference in resistance can be generated between the one side (deviation side) of the center of the side surface, which is the side to which the side-surface member is disposed so as to be deviated, and the other side (non-deviation side) of the center of the side surface.

The present disclosure has been made in view of the above circumstance, and has an object to provide a laminate type battery that makes it possible to reduce the difference in resistance between one side of the center of the side surface and the other side of the center of the side surface.

Means for solving the above problem includes the following aspects.

<1> A laminate type battery comprising:
an electrode body;
a side-surface member that is disposed on a side surface of the electrode body; and
a laminate film that covers the electrode body and a part of the side-surface member, wherein:
the side-surface member is disposed at a position that is deviated from a center of the side surface to one side in a longitudinal direction of the side surface; and
in the side-surface member, a volume of the side-surface member positioned on a deviation side on the side surface is equal to a volume of the side-surface member positioned on a non-deviation side on the side surface, the deviation side being the one side to which the side-surface member is positioned so as to be deviated from the center in the longitudinal direction of the side surface, the non-deviation side being the other side in the longitudinal direction of the side surface.

<2> The laminate type battery according to <1>, wherein the side-surface member has a shape in which a thickness of the side-surface member continuously decreases from the non-deviation side toward the deviation side.

<3> The laminate type battery according to <1>, wherein the side-surface member has a hole formed at a region on the deviation side of the center of the side surface.

The present disclosure can provide a laminate type battery that makes it possible to reduce the difference in resistance between one side of the center of the side surface and the other side of the center of the side surface.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic perspective view showing an electrode body and a side-surface member in a laminate type battery according to an embodiment of the present disclosure;

FIG. 2A is a schematic side view of the laminate type battery shown in FIG. 1 as viewed from a side-surface direction;

FIG. 2B is a schematic side view of a laminate type battery in another aspect according to the embodiment of the present disclosure as viewed from the side-surface direction;

FIG. 3 is a schematic plan view showing a principal part of a vehicle;

FIG. 4 is a schematic perspective view of a battery module;

FIG. 5 is a plan view showing a state where a top lid of the battery module has been removed; and

FIG. 6 is a schematic view of a battery cell housed in the battery module as viewed from a thickness direction.

### DETAILED DESCRIPTION OF EMBODIMENTS

Embodiments that are examples of the present disclosure will be described below. The descriptions show exemplary embodiments, and do not limit the scope of the disclosure.

### Laminate Type Battery

A laminate type battery according to an embodiment of the present disclosure is a laminate type battery including: an electrode body; a side-surface member that is disposed on a side surface of the electrode body; and a laminate film that covers the electrode body and a part of the side-surface member, in which the side-surface member is disposed at a position that is deviated from a center of the side surface to one side in a longitudinal direction of the side surface.

Moreover, in the side-surface member, the volume of the side-surface member positioned on a deviation side on the side surface is equal to the volume of the side-surface member positioned on a non-deviation side on the side surface. The deviation side is the one side to which the side-surface member is positioned so as to be deviated from the center in the longitudinal direction of the side surface, and the non-deviation side is the other side in the longitudinal direction of the side surface.

When the side-surface member is disposed at a position that is deviated from the center of the side surface to one side in the longitudinal direction of the side surface (that is, at a position that is different from the center of the side surface), the volume of the side-surface member is relatively larger on the one side (deviation side) of the center of the side-surface member, which is the side to which the side-surface member is disposed so as to be deviated, and the volume of the side-surface member is relatively smaller on the other side (non-deviation side) of the center of the side-surface member. Therefore, the resistance is lower on the deviation side on which the volume of the side-surface member is relatively larger, and the resistance is higher on the non-deviation side on which the volume of the side-surface member is relatively smaller. That is, the difference in resistance is generated between the deviation side and non-deviation side on the side surface.

However, in the laminate type battery according to the embodiment of the present disclosure, the volume of the side-surface member on the deviation side of the center of the side surface is equal to the volume of the side-surface member on the non-deviation side of the center of the side surface. Therefore, it is possible to restrain the resistance of one of the deviation side and non-deviation side on the side surface from becoming larger, and it is possible to reduce the difference in resistance between the deviation side and non-deviation side on the side surface.

The laminate type battery according to the embodiment of the present disclosure will be specifically described below with examples, using the drawings.

The figures are schematically shown, and sizes and shapes of parts are exaggerated when appropriate, to facilitate understanding.

### First Aspect

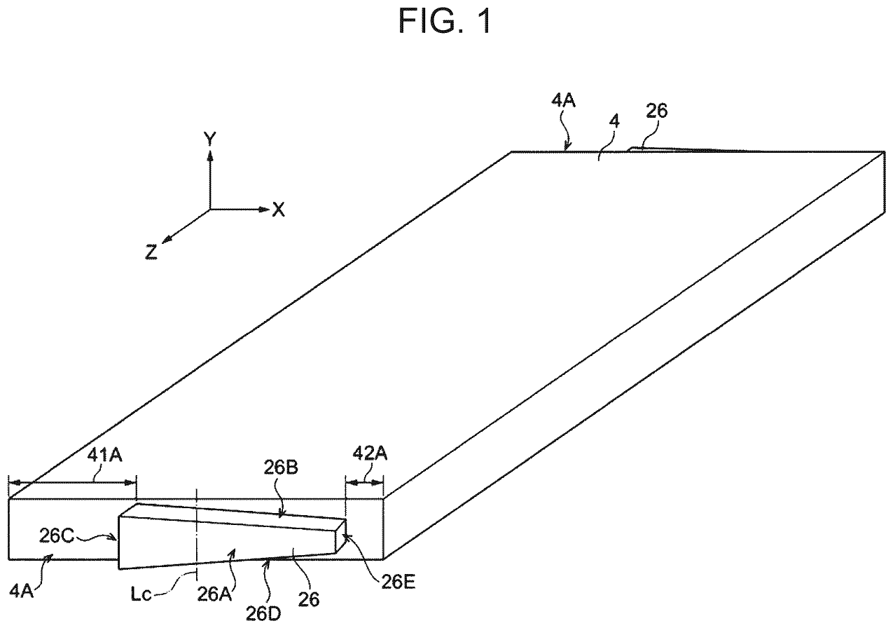

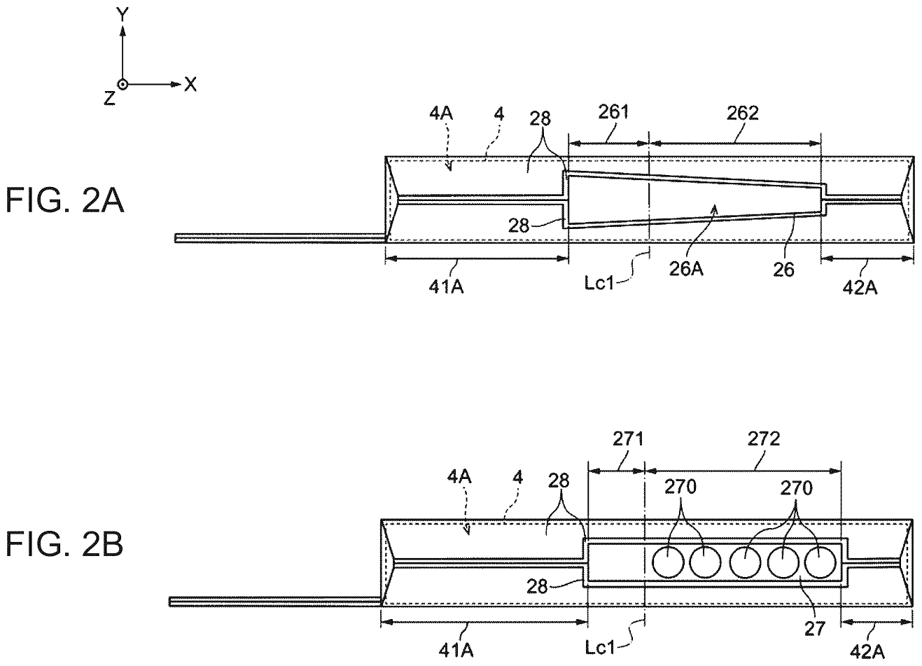

FIG. 1 is a schematic perspective view showing an electrode and a side-surface member in a laminate type battery according to a first aspect of the embodiment of the present disclosure. FIG. 2A is a schematic side view of the laminate type battery shown in FIG. 1 as viewed from a side-surface direction (a direction of a surface on which the side-surface member is disposed, a Z-direction in FIG. 1, FIG. 2A and FIG. 2B).

As shown in FIG. 1, an electrode body 4 in the laminate type battery according to the first aspect includes terminals 26 as examples of the side-surface member. The terminals 26 are respectively disposed on a pair of side surfaces 4A of the electrode body 4. On the side surface 4A of the electrode body 4, two regions 41A, 42A where the terminal 26 is not disposed exist on both sides of the terminal 26 in the longitudinal direction (the direction of an arrow X) of the side surface 4A.

The terminal 26 is disposed at a position that is deviated from a center Lc1 of the side surface 4A of the electrode body 4 to one side in the longitudinal direction (the direction of the arrow X) of the side surface 4A (at a position that is deviated in the right direction in FIG. 1 and FIG. 2A). In the present disclosure, the one side to which the terminal 26 is positioned so as to be deviated from the center Lc1 in the longitudinal direction (the direction of the arrow X) of the side surface 4A is referred to as a “deviation side”, and the other side in the longitudinal direction (the direction of the arrow X) of the side surface 4A is referred to as a “non-deviation side”.

On the side surface 4A of the electrode body 4, the region 42A where the terminal 26 is not disposed on the side (deviation side) to which the terminal 26 is disposed so as to be deviated is narrower in area than the other (non-deviation side), and the region 41A on the non-deviation side is wider in area than the region 42A on the deviation side. Hereinafter, for the two regions that are on the side surface of the electrode body and where the side-surface member is not disposed, the region having a wider area is referred to as a “wide-region”, and the region having a narrower area is referred to as a “narrow-region”.

In the laminate type battery according to the first aspect, as shown in FIG. 2A, a laminate film 28 is disposed so as to cover the electrode body 4 and a part of the terminal 26. The laminate film 28 is disposed so as to cover all surfaces of the electrode body 4, and the whole of the region that is on the side surface 4A of the electrode body 4 and where the terminal 26 is not provided is covered with the laminate film 28 (therefore, in FIG. 2A, the electrode body 4 covered with the laminate film 28 is shown by a dotted line). Further, the laminate film 28 is disposed on the terminal 26, so as to cover at a part of each of an upper surface 26B, one side surface 26C, a lower surface 26D and the other side surface 26E of the terminal 26, more specifically, so as to cover regions that are on the four surfaces and that are on the electrode body 4 side. Accordingly, on the terminal 26, the whole of an outside surface 26A, and regions that are on the upper surface 26B, the one side surface 26C, the lower surface 26D and the other side surface 26E and that are on the opposite side of the electrode body 4 are exposed without being covered with the laminate film 28.

Moreover, the terminal 26 has a shape in which the thickness of the terminal 26 continuously decreases toward the side to which the terminal 26 is disposed so as to be deviated, that is, from the non-deviation side toward the deviation side. In the description with use of the two regions 41A, 42A that are on the side surface 4A of the electrode body 4 and where the terminal 26 is not disposed, the thickness of the terminal 26 continuously decreases from the side of the region (wide-region) 41A having a wider area toward the side of the region (narrow-region) 42A having a narrower area. The thickness of the terminal 26 means the length in a Y-direction in FIG. 1 and FIG. 2A. By this configuration, the terminal 26 is configured such that the volume at a region 261 on the non-deviation side of the center Lc1 of the side surface 4A is equal to the volume at a region 262 on the deviation side of the center Lc1 of the side surface 4A.

The laminate type battery shown in FIG. 1 and FIG. 2A is configured such that the volume of the side-surface member on the deviation side of the center of the side surface is equal to the volume of the side-surface member on the non-deviation side of the center of the side surface, as described above, and therefore, makes it possible to reduce the difference in resistance between the deviation side and non-deviation side on the side surface.

The aspect in which the terminal 26 has a shape in which the thickness of the terminal 26 continuously decreases from the non-deviation side toward the deviation side has been described with FIG. 1 and FIG. 2A. However, without being limited to this aspect, for example, it is allowable to adopt an aspect in which the side-surface member has a shape in which the thickness of the side-surface member decreases from the non-deviation side toward the deviation side in a stepwise manner.

### Second Aspect

FIG. 2B is a schematic side view of a laminate type battery according to a second aspect of the embodiment of the present disclosure as viewed from the side-surface direction (the direction of the surface on which the side-surface member is disposed, the Z-direction in FIG. 2A and FIG. 2B).

In the laminate type battery in the second aspect, the configuration other than a terminal as an example of the side-surface member is the same as that in the laminate type battery in the first aspect, and therefore, detailed descriptions are omitted.

As shown in FIG. 2B, an electrode body 4 in the laminate type battery according to the second aspect includes terminals 27 as examples of the side-surface member. The terminals 27 are respectively disposed on a pair of side surfaces 4A of the electrode body 4. On the side surface 4A of the electrode body 4, two regions 41A, 42A where the terminal 27 is not disposed exist on both sides of the terminal 27 in the longitudinal direction (the direction of the arrow X) of the side surface 4A.

The terminal 27 is disposed at a position that is deviated from a center Lc1 of the side surface 4A of the electrode body 4 to one side in the longitudinal direction (the direction of the arrow X) of the side surface 4A (at a position that is deviated in the right direction in FIG. 2B). In the present disclosure, the one side to which the terminal 27 is positioned so as to be deviated from the center Lc1 in the longitudinal direction (the direction of the arrow X) of the side surface 4A is referred to as a “deviation side”, and the other side in the longitudinal direction (the direction of the arrow X) of the side surface 4A is referred to as a “non-deviation side”.

On the side surface 4A of the electrode body 4, the region 42A where the terminal 27 is not disposed on the side (deviation side) to which the terminal 27 is disposed so as to be deviated is narrower in area than the other (non-deviation side), and the region 41A on the non-deviation side is wider in area than the region 42A on the deviation side.

Moreover, the terminal 27 has five holes 270 formed at a region 272 on the deviation side of the center Lc1 of the side surface 4A. The holes 270 have a hollow shape, and therefore, the regions of the holes 270 are not included in the volume of the terminal 27. Since the holes 270 that are not included in the volume of the terminal 27 are formed at the region 272 of the terminal 27 on the deviation side, the volume of the terminal 27 at the region 272 on the deviation side is reduced. Thereby, the terminal 27 is configured such that the volume at a region 271 on the non-deviation side of the center Lc1 of the side surface 4A is equal to the volume at the region 272 on the deviation side of the center Lc1 of the side surface 4A.

The laminate type battery shown in FIG. 2B is configured such that the volume of the side-surface member on the deviation side of the center of the side surface is equal to the volume of the side-surface member on the non-deviation side of the center of the side surface, as described above, and therefore, makes it possible to reduce the difference in resistance between the deviation side and non-deviation side on the side surface.

The aspect in which the five holes 270 having a circular shape are formed has been described with FIG. 2B. However, without being limited to this aspect, the shape of the hole and the number of holes can be freely altered.

Next, a battery module, a battery pack, and a vehicle that include the laminate type battery according to the embodiment of the present disclosure will be described with use of the drawings.

### Overall Configuration of Vehicle 100

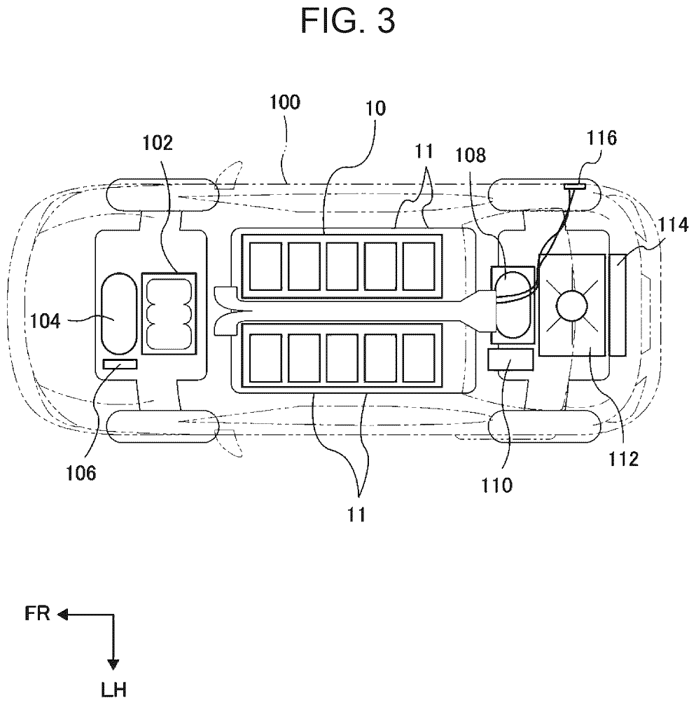

FIG. 3 is a schematic plan view showing a principal part of a vehicle 100 to which a battery pack 10 according to an embodiment is applied. As shown in FIG. 3, the vehicle 100 is a battery electric vehicle (BEV) in which the battery pack 10 is equipped under a floor. In the figures, an arrow UP, an arrow FR, and an arrow LH show the upward direction of the vehicle-height direction, the forward direction of the vehicle front-rear direction, and the leftward direction of the vehicle-width direction, respectively. Forward, rearward, leftward, rightward, upward and downward directions that are used in descriptions mean the forward and downward directions of the vehicle front-rear direction, the leftward and rightward directions of the vehicle-width direction, and the upward and downward directions of the vehicle-height direction, unless otherwise mentioned.

As an example of the vehicle 100 in the embodiment, a DC-DC converter 102, an electric compressor 104, and a positive temperature coefficient (PTC) heater 106 are disposed on a vehicle forward side of the battery pack 10. Further, a motor 108, a gearbox 110, an inverter 112, and a battery charger 114 are disposed on a vehicle rearward side of the battery pack 10.

Direct current output from the battery pack 10 is supplied to the electric compressor 104, the PTC heater 106, the inverter 112, and the like, after the adjustment of the voltage by the DC-DC converter 102. Further, electric power is supplied to the motor 108 through the inverter 112, and thereby rear wheels rotate, so that the vehicle 100 travels.

A charging inlet 116 is provided at a right side portion of a rear portion of the vehicle 100. A charging plug of unillustrated external charging equipment is connected to the charging inlet 116, and thereby, electric power can be stored in the battery pack 10 through the battery charger 114.

Dispositions, structures and others of components that constitute the vehicle 100 are not limited to the above-described configuration. For example, the present disclosure may be applied to a hybrid electric vehicle (HEV) or plug-in hybrid electric vehicle (PHEV) that is equipped with an engine. Further, in the embodiment, a rear-wheel-drive vehicle in which the motor 108 is equipped at the rear portion of the vehicle is adopted. However, without being limited to this, a front-wheel-drive vehicle in which the motor 108 is equipped at a front portion of the vehicle may be adopted, and a pair of motors 108 may be equipped at the front portion and rear portion of the vehicle. Furthermore, a vehicle in which an in-wheel motor is included in each wheel may be adopted.

The battery pack 10 is configured to include a plurality of battery modules 11. In the embodiment, as an example, ten battery modules 11 are provided. Specifically, five battery modules 11 are arrayed in the vehicle front-rear direction on the right side of the vehicle 100, and five battery modules 11 are arrayed in the vehicle front-rear direction on the left side of the vehicle 100. Further, the battery modules 11 are electrically connected to each other.

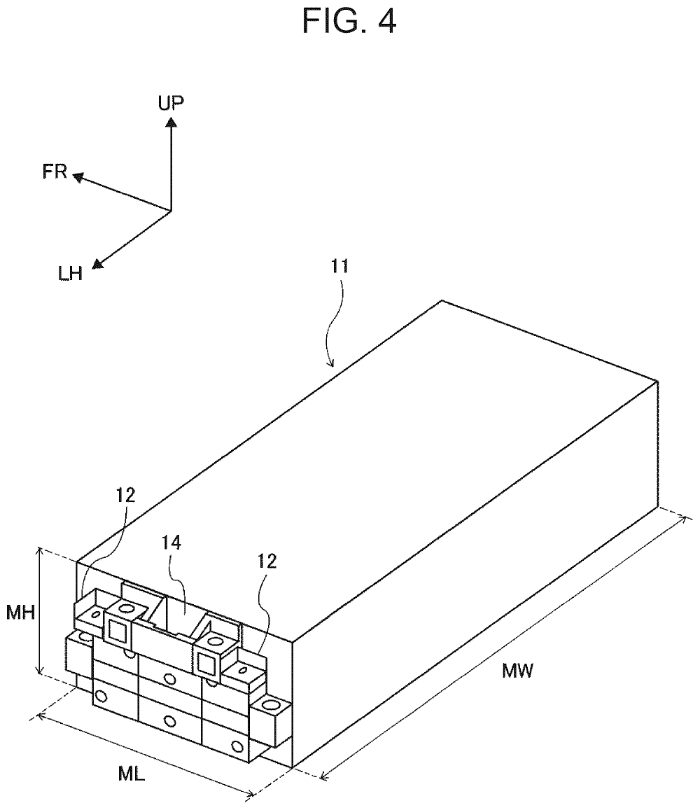

FIG. 4 is a schematic perspective view of the battery module 11. As shown in FIG. 4, the battery module 11 is formed in a roughly rectangular parallelepiped shape in which the longitudinal direction is the vehicle-width direction. Further, an outer shell of the battery module 11 is formed of an aluminum alloy. For example, aluminum die-casts are joined to both end portions of an extruded material composed of the aluminum alloy, by laser welding or the like, and thereby the outer shell of the battery module 11 is formed.

A pair of voltage terminals 12 and a connector 14 are provided on both end portions of the battery module 11 in the vehicle-width direction. A later-described flexible printed wiring board 22 is connected to the connector 14. Further, unillustrated bus bars are welded to both end portions of the battery module 11 in the vehicle-width direction.

A length MW of the battery module 11 in the vehicle-width direction is 350 mm to 600 mm, for example. A length ML in the vehicle front-rear direction is 150 mm to 250 mm, for example. A height MH in the vehicle-height direction is 80 mm to 110 mm, for example.

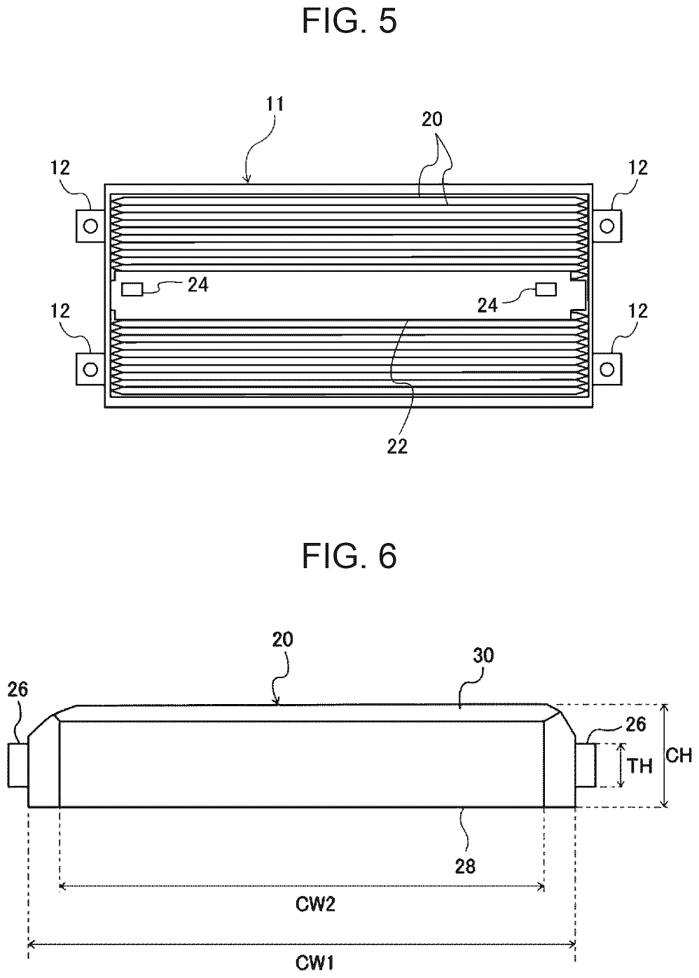

FIG. 5 is a plan view showing a state where a top lid of the battery module 11 has been removed. As shown in FIG. 5, in the interior of the battery module 11, a plurality of battery cells 20 is housed so as to be arrayed. In the embodiment, as an example, 24 battery cells 20 are arrayed in the vehicle front-rear direction, and are bonded to each other.

The flexible printed wiring board (FPC: Flexible Printed Circuit) 22 is disposed on the battery cells 20. The flexible printed wiring board 22 is formed in a belt shape in which the longitudinal direction is the vehicle-width direction, and thermistors 24 are provided at both end portions of the flexible printed wiring board 22, respectively. The thermistors 24 are not bonded to the battery cells 20, and are configured to be pressed to the battery cell 20 side by the top lid of the battery module 11.

Further, a single or a plurality of unillustrated buffer materials is housed in the interior of the battery module 11. For example, the buffer material is a thin-plate member that can elastically deform, and is disposed between adjacent battery cells 20 such that the thickness direction of the buffer material is the arraying direction of the battery cells 20. In the embodiment, as an example, buffer materials are disposed at both longitudinal-directional end portions and longitudinal-directional central portions of the battery module 11.

FIG. 6 is a schematic view of the battery cell 20 housed in the battery module 11 as viewed from a thickness direction. As shown in FIG. 6, the battery cell 20 is formed in a roughly rectangular plate shape, and an unillustrated electrode body is housed in the interior. The electrode body is configured such that a positive electrode, a negative electrode and a separator are stacked, and is sealed by the laminate film 28.

In the embodiment, as an example, the sheet-shaped laminate film 28 after embossing is folded and pasted to each other, and thereby a housing portion for the electrode body is formed. Both a single-cup embossing structure in which embossing is performed at a one spot and a double-cup embossing structure in which embossing is performed at two spots can be employed. In the embodiment, a single-cup embossing structure in which the draw depth is about 8 mm to 10 mm is employed.

Upper ends of both longitudinal-directional end portions of the battery cell 20 are folded, and the corners constitute an outer shape. Further, an upper end portion of the battery cell 20 is folded, and a fixing tape 30 is put on the upper end portion of the battery cell 20 along the longitudinal direction.

Terminals (tabs) 26 are provided at both longitudinal-directional end portions of the battery cell 20, respectively. In the embodiment, as an example, the terminals 26 are provided at offset positions below the center of the battery cell 20 in the height direction of the battery cell 20. The terminals 26 are joined to unillustrated bus bars by laser welding or the like.

A length CW1 of the battery cell 20 in the vehicle-width direction is 530 mm to 600 mm, 600 mm to 700 mm, 700 mm to 800 mm, 800 mm to 900 mm, or 1000 mm or more, for example. A length CW2 of a region where the electrode body is housed is 500 mm to 520 mm, 600 mm to 700 mm, 700 mm to 800 mm, 800 mm to 900 mm, or 1000 mm or more, for example. A height CH of the battery cell 20 is 80 mm to 110 mm, or 110 mm or 140 mm, for example. The thickness of the battery cell 20 is 5.0 mm to 7.0 mm, 7.0 mm to 9.0 mm, or 9.0 mm to 11.0 mm. A height TH of the terminal 26 is 40 mm to 50 mm, 50 mm to 60 mm, or 60 mm to 70 mm.

What is claimed is:

1. A laminate type battery comprising:
an electrode body;
a side-surface member that is disposed on a side surface of the electrode body; and
a laminate film that covers the electrode body and a part of the side-surface member, wherein:
the side-surface member is disposed at a position that is deviated from a center of the side surface to one side in a longitudinal direction of the side surface; and
in the side-surface member, a volume of the side-surface member positioned on a deviation side on the side surface is equal to a volume of the side-surface member positioned on a non-deviation side on the side surface, the deviation side being the one side to which the side-surface member is positioned so as to be deviated from the center in the longitudinal direction of the side surface, the non-deviation side being the other side in the longitudinal direction of the side surface.

2. The laminate type battery according to claim 1, wherein the side-surface member has a shape in which a thickness of the side-surface member continuously decreases from the non-deviation side toward the deviation side.

3. The laminate type battery according to claim 1, wherein the side-surface member has a hole formed at a region on the deviation side of the center of the side surface.
